(19) United States
(12) Patent Application Publication
(10) Pub. No.: US 2025/0363794 A1
(43) Pub. Date: Nov. 27, 2025

(54) SCENE GRAPH GENERATOR

(71) Applicant: Common Wealth Scientific and Industrial Research Organization, Acton (AU)

(72) Inventor: Zeeshan HAYDER, Acton (AU)

(21) Appl. No.: 19/209,592

(22) Filed: May 15, 2025

(30) Foreign Application Priority Data
May 24, 2024 (AU) 2024901537

(51) Int. Cl. G06V 10/82; G06V 10/75

(52) U.S. Cl. CPC G06V 10/82; G06V 10/751

(57) ABSTRACT

A system and method are provided for analysing image data representing an image, the image representing multiple objects in the image with respective positional information. An exemplary method includes calculating an embedding of the image data, the embedding comprising an embedding vector for each object, and encoding object information and the positional information; and evaluating a trained machine learning model on the embedding to calculate connection probabilities of pair-wise connections between each of the objects, the connection probabilities representing relationships between the objects in the image.

### CROSS-REFERENCE TO RELATED APPLICATIONS

The present application is based on and claims priority of Australian Application No. 2024901537 filed on May 24, 2024, the disclosure of which is incorporated by reference herein in its entirety.

### TECHNICAL FIELD

This disclosure relates to methods and systems for generating scene graphs from images.

### BACKGROUND

Scene graph generation aims to capture detailed spatial and semantic relationships between objects in an image. This topological representation of an image is helpful for visual understanding and image reasoning tasks such as image caption generation, visual question answering, cross-model retrieval, and human-object interaction recognition. Generating the scene graph is challenging due to incomplete labelling, long-tailed relationship categories, and relational semantic overlap. Further, some methods of scene graph generation are computationally expensive due to the combinatorial complexity.

Therefore, there is a need for an improved method that can generate complex scene graphs reliably with low computational complexity.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each of the appended claims.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY

There is provided a method for analysing image data representing an image, the image representing multiple objects in the image with respective positional information. The method comprises calculating an embedding of the image data, the embedding comprising an embedding vector for each object, and encoding object information and the positional information; and evaluating a trained machine learning model on the embedding to calculate connection probabilities of pair-wise connections between each of the objects, the connection probabilities representing relationships between the objects in the image.

In some embodiments, evaluating the trained machine learning model comprises calculating connection probabilities for each of multiple possible labels for each of the pair-wise connections.

In some embodiments, the labels comprise predicates or location identifiers or both.

In some embodiments, the method further comprises training a machine learning model on training data to obtain the trained machine learning model; the training data comprises ground truth connection values; and the method further comprises calculating a correspondence between ground truth pair-wise connection values and pair-wise connection probabilities to calculate a loss value, and adjusting variable values of the machine learning model to reduce the loss value.

In some embodiments, calculating the loss value comprises calculating an entity matching cost and a relationship matching cost.

In some embodiments, calculating the correspondence comprises solving an assignment problem between a ground truth graph representing the training data and a prediction graph generated by the machine learning model.

In some embodiments, the assignment problem is a quadratic assignment problem and the method comprises solving the quadratic assignment problem in a linear form approximating the quadratic assignment problem.

In some embodiments, evaluating the trained machine learning model comprises combining the embedding vector for each of the multiple objects with the embedding vector for other objects.

In some embodiments, combining the embedding vector comprises evaluating a sigmoid activation function to calculate the connection probabilities.

In some embodiments, the connection probabilities comprise, for each pair-wise connection, a probability value for each of multiple predicate labels.

In some embodiments, the method further comprises selecting a subset of the connection probabilities with the largest value for the connection probabilities.

In some embodiments, the trained machine learning model comprises a multi-layer perceptron to calculate the connection probabilities.

In some embodiments, the trained machine learning model comprises an encoder to calculate the embedding.

In some embodiments, the machine learning model comprises one query for each of the multiple objects to calculate cross-attention values.

In some embodiments, the trained machine learning model further comprises a neural network to detect the objects in the image and to determine the positional information.

A computer system comprises one or more processors configured to perform the above method.

Software, when executed by a computer, causes the computer to perform the above method.

### BRIEF DESCRIPTION OF DRAWINGS

An example will now be described with reference to the following drawings:

FIG. 1 illustrates an image and a corresponding scene graph.

FIG. 2 illustrates a method for analysing image data.

FIG. 3 illustrates an auto-encoder architecture.

FIG. 4 illustrates an example architecture to implement the method of FIG. 2.

FIG. 5 shows a table of Evaluation on the Visual Genome dataset.

FIG. 6 illustrates a computer system for analysing image data.

### DETAILED DESCRIPTION OF EMBODIMENTS

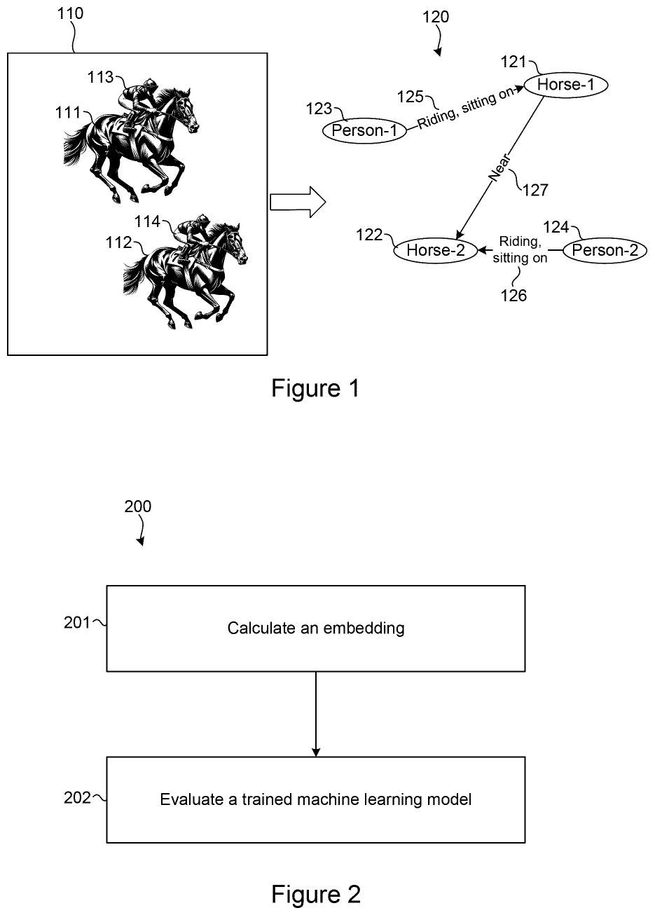

Scene graphs are useful in many areas of computer vision. In particular, scene graphs represent the relationships between objects in an image. FIG. 1 illustrates an image 110 that shows two race horses 111, 112 ridden by two persons 113, 114 and a corresponding scene graph 120. The image is captured, stored and transmitted as image data, which means that the image comprises multiple pixels and each pixel has an intensity value for different colour channels, respectively. The image data may be stored in the form of an image file format, such as Joint Photographic Experts Group (JPG), bitmap (BMP), or others. The image data may be non-pixel based, such as parametric formats including vector graphics, spline representations etc. In some examples, non-pixel formats may be converted to a pixel-based format before performing the methods disclosed herein.

In FIG. 1, the scene graph 120 comprises nodes for horses 121, 122 and persons 123, 124 and edges to represent relationships between the nodes. For example, a first edge 125 connects the first person node 123 with the first horse node 121 to indicate a relationship between the first person 113 and the first horse 111. In this example, edge 125 is labelled to characterise the relationship. This label may be a predicate (such as an action or a verb) or a location or another relationship label. The set of possible labels is not restricted and simply depends on the labels provided in the training data. It is noted that, due to the transformer architecture, the method combines similar labels or more specifically, semantically similar labels lead to similar embeddings. Each edge may also labelled with more than one label. Here, the first edge 125 is labelled with the two labels of “riding, sitting on” to characterise the relationship between person 113 and horse 111.

Similarly, there is a second edge 126 also labelled “riding, sitting on”. While the first edge 125 and second edge 126 each form a triplet of subject, predicate and object, they do not fully characterise the image data because there is a further relationship between the first horse 111 and the second horse 112. This is indicated by a third edge 127, which is labelled with the location label “Near”.

This shows that there could be potentially many edges for many objects and each edge could have multiple labels from a large number of potential labels. The disclosed method provides for a machine learning model that is trained to extract those edges and labels. More particularly, the machine learning model calculates a probability between each two objects, which form a pair. Pairs which a high probability are likely to have a relationship in the image while pairs with low probability are likely unrelated. Further, the machine learning model calculates the probability for each label (e.g., predicate). Those label-specific probabilities are calculated independently, so that each pair can have multiple highly-likely labels.

The disclosed machine learning model is trained using training image data. This means there is training image data of images with identified objects and identified relationships with labels between the objects. This training data is then provided to the machine learning model and a prediction error is minimised by adjusting the weights of the model, such as through back-propagation. The trained machine learning model can then be used to predict relationships in previously unseen image data.

### Method

FIG. 2 illustrates a method 200 for analysing image data. As set out above, the image data represents an image and the image comprises multiple objects with respective positional information. A formal notation is introduced below. In summary, there is a set of objects and each object comprises further properties including object type or category and the position. The position may be expressed as a bounding box including x/y-centre location, x-size, y-size. The position may also be expressed as a subset of pixels in the image.

Method 200 comprises calculating 201 an embedding of the image data. The embedding comprising an embedding vector for each object, and encoding object information and the positional information.

### Embeddings

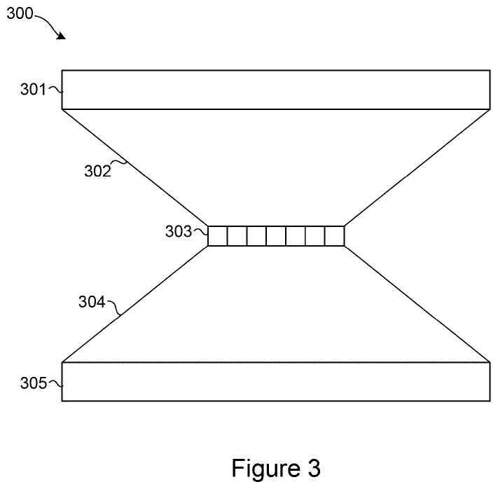

FIG. 3 illustrates an auto-encoder architecture 300 that can be used to calculate an embedding. The auto-encoder architecture 300 comprises an input 301, an encoder 302, an embedding 303, a decoder 304 and an output 305. During training, the output 305 is compared to the input 301 and a difference between output 305 and input 301 is minimised. This would be straight-forward if there was a direct connection between each input node to each output node. However, there is an embedding 303 that is smaller than the input 301 and the output 305. Therefore, the auto-encoder architecture 300 learns to generate the best possible output 305 (that is as close as possible to the input 301) for a range of different inputs, using only the limited number of parameters in the embedding 303. As a result, the encoder 302 is trained to generate an embedding 303 that is most suited to represent the input with the limited number of parameters of the embedding 303.

The encoder 302 can then be used for test images that were not used for training to calculate a compact representation of those test images. This compact representation is referred to as an embedding. In that sense, an embedding is the result of a data reduction method. In the example here, the embedding is optimised to reduce the amount of data while preserving the largest amount of detail given the training image data. It is noted that in the examples presented herein, the input 301 comprises object data, such as type, as well as positional information in the image. As a result, the embedding 303 encodes, in a compact representation that is smaller than the original input data, the object information as well as the positional information.

It is noted that it would be possible to build an architecture that has input nodes for object information and positional information and uses this input directly to learn a scene graph. However, the training data and training time heavily depends on the number of nodes and connections in the network. Therefore, reducing the size of the data into the embedding 303 reduces the amount of training data and the time to train the model significantly.

### Inference

Returning to FIG. 2, method 200 further comprises evaluating 202 a trained machine learning model on the embedding 303 to calculate connection probabilities of pair-wise connections between each of the objects. This is also referred to as “inference”. The connection probabilities represent relationships between the objects in the image. It is noted that the trained machine learning model may be integrated with the encoder 302 shown in FIG. 3. This may also mean that the encoder is not trained separately as shown in FIG. 3 but trained together with the machine learning model that calculates the connection probabilities.

As described more formally below, the machine learning model may calculate for every possible pair of two objects the relationship probability as represented by a two-dimensional adjacency matrix. Further, the machine learning model may calculate for every possible pair of two objects and for every possible label the relationship probability as represented by a three-dimensional adjacency matrix. Each pair has an associated relationship probability for each label (e.g. predicate) and each relationship probability may be a decimal number. It is noted that the relationship probabilities are between 0 and 1 in most examples, but it is equally possible to define relationship probabilities less strictly to not be bound between 0 and 1. It is further noted that the probabilities for multiple labels for one pair do not need to add up to one because multiple labels are possible for each connection.

One complexity that arises is that the machine learning models, such as neural networks, are fixed in their structure. On the other hand, the number of objects in an image can vary, so the full adjacency matrix may be of different size for different images. In order to solve this problem, this disclosure provides for a dense relational embedding between every pair of nodes in the graph. That is, there are two vectors, referred to as query vectors, of fixed length and the cross product between the query vectors represent an embedded adjacency table. In effect, this means that the model combines the embedding vector for each of the multiple objects with the embedding vector for other objects. In this process, the model may apply a sigmoid function to calculate the connection probabilities. As a result, the queries implements a cross-attention mechanism to calculate cross-attention values that then can be used to calculate the connection probabilities.

Again, since the query vectors are of fixed length, the embedding matrix is also of fixed size. The query vectors are trained similar to the auto-encoder architecture 300 so that the best possible prediction on the relationship graph can be achieved.

The entries of the embedding adjacency table can then be used as input to a trained machine learning model, such as a multi-layer perceptron (MLP) to predict the relationship probability between each two objects.

### Training

To set the parameter values for the machine learning model, including the object encoder, the relational encoder and the MLP, a training is performed on training data to obtain the trained machine learning model. The training data comprises ground truth connection values, which includes for each training image an indication of which objects are connected. This training data may be generated by human labelling, by rendering 3D object models or other methods. The training process involves calculating a correspondence between ground truth pair-wise connection values and calculated pair-wise connection probabilities (as calculated by the machine learning model) to calculate a loss value. The process then adjusts variable values of the machine learning model to reduce the loss value. One method for adjusting the variable values may be gradient descent and back-propagation.

Calculating the loss value may have a number of different components and may comprises calculating an entity matching cost and a relationship matching cost. The entity matching cost reflects the error in matching the objects in the image while the relationship matching cost reflects the error in predicting the correct relationships.

Since the labelling of the training data comprises relationship information that defines a relationship graph, calculating the correspondence comprises solving an assignment problem between a ground truth graph representing the training data and a prediction graph generated by the machine learning model.

The assignment problem is a combinatorial optimization problem and, in its original formulation, involves a set of agents and a set of tasks. Each agent can be assigned to perform any task, incurring some cost that varies depending on the agent-task assignment. The goal is to perform as many tasks as possible by assigning at most one agent to each task and at most one task to each agent, while minimizing the total cost of the assignment.

In graph theory terms, the method seeks a matching in a weighted bipartite graph, where the sum of edge weights (representing assignment costs) is minimized. When the total cost of the assignment for all tasks equals the sum of the costs for each agent (or the sum of the costs for each task), the assignment is called a linear assignment.

In some examples, the assignment problem is a quadratic assignment problem. However, this disclosure provides (details below) a way of solving the quadratic assignment problem in a linear form approximating the quadratic assignment problem.

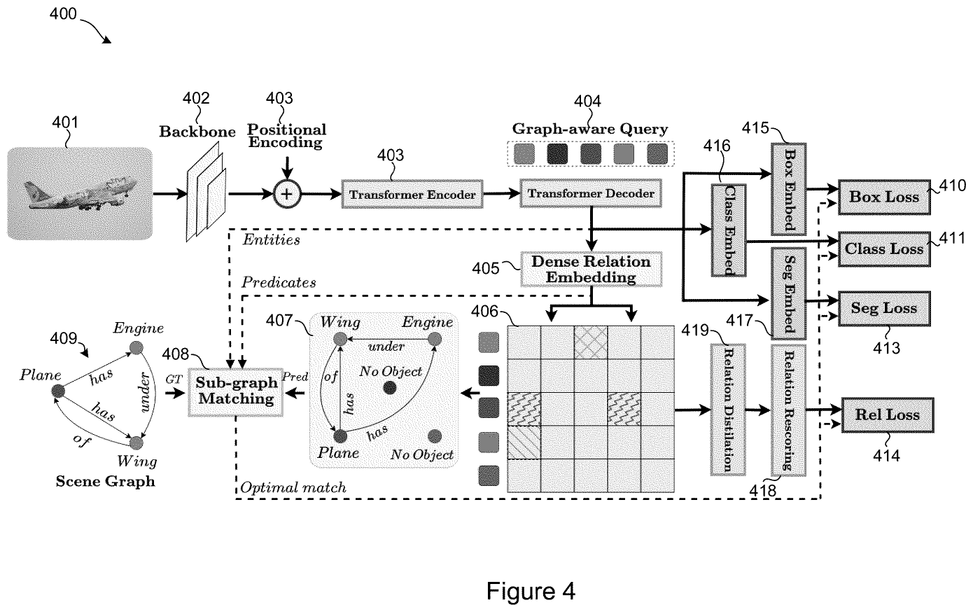

FIG. 4 illustrates an example architecture 400 for implementing method 200. An input image 401 is used as an input to an object classification backbone 402, such as a convolutional neural network (CNN). The output of the classification backbone 402 is combined with positional encoding 403 as described herein. The result is processed by a transformer encoder 403 and transformer decoder 404 as explained with reference to FIG. 3. The encoder/decoder structure generates the object embedding, which is then provided to dense relation embedding module 405 that generates an embedding of the relationships so that a fixed size embedding or query is available regardless of the number of objects detected by backbone 402.

The relational embedding enables calculation of relationship probabilities between any two objects detected by backbone 402. These relationships can be calculated by simply iterating over all objects and for each object, iterating over all possible other objects to form all possible pairs and then calculating a probability value for each label (e.g., predicate). This label probability then defines the edges in a scene graph 407, where the nodes are formed by the objects detected by backbone 402.

The scene graph 407 is the output of inference, that is, the application of architecture 400 to calculate a scene graph for a new (unlabelled) image.

For training, the calculated scene graph 407 is fed into a sub-graph matching module 408 that also receives a ground-truth graph 409 that represents the ground-truth from a labelled training image. The ground-truth graph 409 comprises connections (i.e. high connection probabilities) between the objects in the training image. In the ground-truth graph 409, each edge and label may be encoded by a probability of ‘1’, which is then matched to the probability for that label in the scene graph 407.

The result of the matching is then provided to a box loss module 410, a class loss module 411, a segmentation loss module 413 and a relationship loss module 414.

The box loss module 410 also receives the output of a box embedding module 410. The class loss module 411 also receives the output of a class embedding module 416. The segmentation loss module 413 also receives the output of a segmentation embedding module 417. Finally, the relationship loss module 414 also receives an output from a relation re-scoring module 418, which, in turn, receives an output from a relation distillation module 419, which are described in more detail below. The re-scoring module 418 may select a subset of the connection probabilities with the largest value for the connection probabilities. That is, the re-scoring module 418 may apply a threshold on the connection probability or rank the connection probabilities and only select the top 10.

The box loss module 410, class loss module 411, segmentation loss module 413 and relationship module 414 calculate the loss for their respective purpose and therefore enable training of the architecture 400 as a single model. In other words, the entire parameter set of architecture 400 is trained to minimise those loss values. The result is a trained machine learning model that can then be used for inference as explained above.

### Formal Notation

Given an image [symbol] ∈ [symbol] ^{H×W×3}, one objective is to construct a comprehensive graph [symbol] that encapsulates the visual relationships and contextual associations in the provided image. The graph's nodes are a collection of entities [symbol] in the image. “Entities” and “objects” is used interchangeably herein. The edges in the graph reflect the visual relationships [symbol] (also referred to as “connections”) among these nodes. The graph is thus symbolically represented as [symbol] =( [symbol] , [symbol] ). Let the total number of nodes in the graph be M. In the scene graph generation task, the representation of each entity [symbol] ᵢ=(cᵢ, bᵢ) involves its object category cᵢ, and a bounding box bᵢ∈ [0,1]⁴. In contrast, the panoptic scene graph generation task introduces an additional attribute, namely, a pixel-wise semantic segmentation mask mᵢ ∈ [symbol] ^{H×W}, to characterize each entity, as [symbol] ᵢ=(cᵢ, bᵢ, mᵢ). The unique object categories are denoted as [symbol] ∈ {c₁, C₂, . . . , c_{c}}, where C represents the total number of object categories in the dataset. Moreover, edge vector [symbol] _{i,j}=( [symbol] ᵢ, r_{i,j}, [symbol] ⱼ) within the graph symbolize the relationships among the entities [symbol] ᵢ and [symbol] ⱼ, often denoted as subject and object respectively. The set of relationships (also referred to as “labels” herein) among all the entities is called a predicate set, denoted as [symbol] ∈ {r₁, r₂, . . . , r_{P}}, where P is the number of unique relations. The list of all the edges in an image is often called a relational triplet set [symbol] . This triplet set can be described by an adjacency matrix as [symbol] ∈ [symbol] ^{M×M×P}. Note that these edges are directed and the graph [symbol] can have multiple edges among the same pair of entities. The overall process involves correctly predicting this set [symbol] . During inference, the trained models are expected to predict this ground truth triplet set using just top-K predicted triplets, denoted as [symbol] .

### Model Architecture

As mentioned above, FIG. 4 illustrates the disclosed network for scene graph generation. The scene graph generation may be a directed graph prediction task with ground truth graph [symbol] and the predicted graph [symbol] .

The disclosed network may comprise a single-stage transformer-based network consisting of a backbone network and an encoder-decoder network module. In particular, the image undergoes an initial forward pass through a backbone network 402, utilizing ResNet-50, Swin-B, or Swin-L or another network.

Subsequently, positional encoding is added to the image features before they undergo processing through a transformer encoder 403. There is a graph-aware query [symbol] to extract the full graph structure from the transformer's output tokens. This query learns the object features as well as the outgoing edge features for an object. The transformer layers are used to learn these graph-aware queries.

Let N be the total number of graph-aware queries in the network. Each query, [symbol] , represents only the directed edges starting from a node to all other nodes (including to itself), these can be used to learn the node-specific attributes such as object class, bounding box as well as the segmentation mask directly, denoted as [symbol] ᵢ=(ĉᵢ, \hat{b}ᵢ, \hat{m}ᵢ). However, the information represented by each individual token may not be enough to learn the full relationship with other objects. The method generates the compositional tokens [symbol] ∈ [symbol] ^{N×N×P} on the fly which are created in a pairwise manner. The [symbol] are further forwarded through a series of multi-layer perceptron (MLP) layers to learn the pairwise relation embeddings. These embeddings are further forwarded through a sigmoid layer to generate a probability map, representing the estimated dense edges of the graph [symbol] . The estimated [symbol] and [symbol] are further combined to generate the final predicted graph [symbol] .

The objective function is to have a perfect matching among all the nodes in the graph. However, this matching can only be attained when all the node attributes (cᵢ, bᵢ, and mᵢ) match as well as their relation triplets. Specifically, the method aims to approximate the relation probability for the predicted graph [symbol] ,

$$p ( {\hat{𝕍}}_{i} , {\hat{𝕍}}_{j} , {\hat{𝔼}}_{i j} ) = p ( {\hat{𝔼}}_{i j} \vert {i}_{} , {j}_{} ) \qquad ( 1 )$$

where p ( [symbol] ᵢⱼ| [symbol] ᵢ, [symbol] ⱼ) denotes the probability of the predicate given the graph-aware queries [symbol] ᵢ and [symbol] ⱼ.

The number of nodes in the predicted graph [symbol] and its ground truth counterpart [symbol] may vary. Therefore, this disclosure provides a sub-graph matching approach to ascertain the correspondence between nodes in the predicted graph and nodes in the ground truth graph. Note that sub-graph matching is an NP-hard problem so the method approximates this with an upper bound. The sub-graph matching provides an approximate match between the nodes in [symbol] and [symbol] . These match indices are further passed to the loss functions for estimating the gradient for the optimizer.

### Dense Scene Graph Generation

One motivation behind predicting a dense graph is that it can capture a more structured representation of the objects in the images. The learned contextual information may allow the model to learn a globally consistent graph by considering relationships between different objects thus making a more informed prediction of the structured scene. This coherent representation can help mitigate the long-tail relations issues of the scene graph datasets. Long-tail means that there are many labels or predicates that occur relatively infrequently.

To this end, the method comprises learning a dense pairwise relation representation, which can generate visual relationship triplets among any node in the graph with higher coverage in an efficient manner. One option would be to augment the number of queries in the transformer network to align with the dense relations. However, this approach introduces significant computational and memory complexity, particularly for transformer-based networks which may be resource intensive.

To tackle this challenge, this disclosure introduces a set of graph-aware queries that learn a compact representation of the object's attributes and its relations with all other objects in the image. This differs from other approaches that predict only a relatively small set of triplets [symbol] for each image, which fall short of capturing the full spectrum of relationships among objects within the graph.

Graph-aware Queries: This disclosure provides graph-aware queries, which can be used to generate compositional tokens efficiently for dense graph prediction. Specifically, the representation of each predicted object is combined with the representations of all other objects, aiming to approximate the dense relational embedding between every pair of nodes in the graph as shown below,

$$p ( {\hat{𝔼}}_{i j} \vert {i}_{} , {j}_{} ) = MLP ( {i}_{} ⊕ {j}_{} ) \qquad ( 2 )$$

Note that ⊕ is a concatenation operator, thus learning a directed graph. The MLP layers are trained to learn multi-label relations [symbol] ∈ [symbol] ^{N×N×P}. A Sigmoid activation function is used to learn the probability for each predicate label. This is in contrast to triplet-based approaches, which employ a Softmax activation and can only learn a single relation ( [symbol] ∈ [symbol] ^{M×P}). For each learned query, the method learns the conditional probability in Equation (2) with a two-step approach.

Relation Distillation: First, the method trains a predicate filter to dynamically reject pairwise relations. Note that, during training the method may not use a predefined set of possible triplets based on training dataset statistics. Instead, the method learns it from the data to capture the missing triplets that may occur in the future. The structured graph learning approach has the potential to leverage related triplets in the images. Specifically, this predicate filter is trained using graph-aware queries. It takes the [symbol] ᵢ as input and computes a cross-attention with all other [symbol] ⱼ to approximate a binary adjacency matrix. However, the Softmax operator in the attention is replaced with a Sigmoid function to attend to multiple queries. It is noted that the Softmax operator generates a probability distribution over multiple outputs of a neural network, for example. As a result, the sum over all output values is 1. In contrast, the sigmoid function maps each output to a value between 0 and 1, so the output is not a probability distribution but each output is independent.

This relation filter [symbol] ∈ [symbol] ^{N×N} is learned as follows.

$$𝔽 = sigmoid ( \frac{\cdot {T}^{}}{\sqrt{{d}_{q}}} ) \qquad ( 3 )$$

This filter learns if there exists at least a single relation for each entity pair rather than finding the exact relation. Moreover, along with the relation filter, the method learns an MLP based on pairwise features to dynamically distil relations.

$$p ( {\hat{𝔼}}_{i j} \vert {𝕊}_{i , j} ) = 𝔽 \cdot p ( {\hat{𝔼}}_{i j} \vert {i}_{} , {j}_{} ) \qquad ( 4 )$$

Relation Re-scoring Secondly, to reward entity queries with a higher object confidence, the method applies a relation re-scoring strategy. It is noted that the proposed approach is not constrained by the requirement that the number of predicates matches the number of relations in the transformer queries. Also, it is possible that a high-scoring object can have no relations. This disclosure provides a re-scoring mechanism and extends it to rank all the pairwise relations. Specifically, the final pairwise relation probability is calculated as follows,

$$p ( {i j}_{} \vert {i , j}_{} ) = p ( {\hat{V}}_{i} \vert {i}_{} ) \cdot p ( {\hat{V}}_{j} \vert {j}_{} ) \cdot p ( {i j}_{} \vert {i}_{} , {j}_{} ) \qquad ( 5 )$$

where p( [symbol] ᵢ) is learned using the corresponding embeddings, encompassing (cᵢ, bᵢ, and mᵢ). The method uses the same re-scoring module as in Equation (5) for both the scene-graph generation and the panoptic scene-graph generation tasks.

Logits Adjustment: The method employs logit adjustments as a post-processing step to mitigate bias in the features resulting from relational noise. Specifically, the method sets the logits adjustment weight to 0.15. Moreover, the method comprises a non-maximum suppression (NMS)-based strategy to eliminate duplicate triplets, relying on bounding boxes for the scene graph generation task and segmentation masks for the panoptic scene graph (PSG) task. Finally, only the top 100 triplets are used to evaluate our method.

### Sub-Graph Matching

Given the generated graph, the method comprises a graph matching procedure for identifying a correspondence between the prediction [symbol] and the ground truth graph [symbol] , with N and M nodes respectively. Without loss of generality, suppose that both graphs have the same order of N. Otherwise, they may be expanded with new dummy nodes that have no relation to any other node in the graph. Specifically, the method adds N−M dummy nodes to make both graphs have the same number of nodes. Similar to the nodes and edges of G defined in Sec. 3.1, the nodes and edges in the predicted graph [symbol] are denoted as { [symbol] ᵢ [symbol] and {\hat{r}_{i,j} [symbol] , respectively.

A correspondence σ_{i,a} between the i^{th} node of [symbol] and the a^{th} node of [symbol] is a bijective function that assigns one node of [symbol] to only one node of [symbol] . The optimal mapping from graph [symbol] to graph [symbol] is \hat{σ}. Then, a generic formulation of the graph matching problem consists of finding the optimal correspondence \hat{σ} given by the solution of a quadratic assignment (QA) problem:

$$\hat{σ} = {arg min}_{∀ σ : 𝔾 \to \hat{𝔾}} \{ {\sum }_{∀ i} {C}_{e} ( {𝕍}_{i} , {\hat{𝕍}}_{σ ( i )} ) + {\sum }_{∀ ( i , j )} {C}_{r} ( {r}_{i , j} , {\hat{r}}_{σ ( i , j )} ) \qquad ( 6 )$$

where Cₑ( [symbol] ᵢ, [symbol] _{σ(i)}) is a pair-wise entity matching cost between ground truth node i and a prediction with index σ(i). Similarly, Cᵣr_{i,j}, \hat{r}_{σ(i,j)}) is a pair-wise relation matching cost between ground truth relation r_{i,j} and a prediction with index σ(i, j). In the current problem, the matching cost takes into account the class prediction, the similarity of predicted and ground truth boxes, and the similarity of predicted and ground truth relations.

Specifically, we define Cₑ( [symbol] ᵢ, [symbol] _{σ(i)}) as 1_{c}_{ᵢ}_{≠Ø}(1−\hat{p}_{σ(i)}(cᵢ))+1_{c}_{ᵢ}_{≠Ø}IoU(bᵢ, \hat{b}_{σ(i)}), where \hat{p}_{σ(i)} is the predicted entity class probability. Similarly, we define Cᵣ(r_{i,j}, \hat{r}_{σ(i,j)}) as 1_{c}_{_{i,}}_{c}_{ⱼ}_{≠Ø}(1−\hat{p}_{σ(i,j)})^{T}r_{i,j}+1_{c}_{ᵢ}_{c}_{ⱼ}_{=Ø}(\hat{p}_{σ(i,j)})^{T}(1−r_{i,j}), where \hat{p}_{σ(i,j)} is predicted relation class probability vector.

As the generic quadratic assignment (QA) problem may be non-deterministic polynomial (NP)-hard, this disclosure introduces an approximation scheme to reduce the computation cost. In particular, the method uses an upper-bound for the quadratic term as below:

$${\sum }_{∀ ( i , j )} {C}_{r} \leq ( 7 )$$

This reduces the QA problem to a linear form and its optimal assignment can be computed efficiently with the Hungarian algorithm. This approximation also allows training this dense relation layer jointly with an end-to-end transformer model, as detailed in the following subsection.

### End-to-End Graph Learning

For the scene graph generation task, the method employs a detection transformer (DETR) with query denoising and train N graph-aware queries. Conversely, in the panoptic scene graph generation task, the method also trains N graph-aware queries. The sub-graph matching finds a node assignment in the predicted graph. During training, the overall objective is based on a multi-task loss, which contains the bounding box L1 loss [symbol] _{box}, the generalised intersection over union (GIoU) loss [symbol] _{giou}, the entity classification loss [symbol] ₑₙₜ, and the pairwise relation loss [symbol] ᵣₑₗ. This multi-task loss [symbol] is formulated as:

$$𝕃 = {λ}_{b o x} {𝕃}_{b o x} + {λ}_{giou} {𝕃}_{g i o u} + {λ}_{ent} {𝕃}_{ent} + {λ}_{r e l} {𝕃}_{r e l} , \qquad ( 8 )$$

where [symbol] ᵣₑₜ refers to a focal loss that is applied to all pairwise edges in the extended graph. The hyper-parameters used to weight each loss are λ_{box}, λ_{giou}, λₑₙₜ, and λᵣₑₗ. The method may also train segmentation focal and dice losses, [symbol] _{dice} and [symbol] _{focal}, with λ_{dice}=λ_{focal}=1 for panoptic scene graph generation. In addition to this, the relation accuracy is improved by leveraging logit adjustment at the time of inference. Note that the disclosed model is trained in an end-to-end manner for both scene graph and panoptic scene graph generation tasks.

### Computer System

FIG. 6 illustrates a computer system 600 for analysing image data representing an image. Computer system comprises a processor 601 configured to perform method 200 in FIG. 2 by way of program code stored on a non-transitory computer readable medium, such as non-volatile memory 602. Computer system 600 further comprises volatile memory 603 to store temporary variable values during processing. Computer system 600 may further comprise a camera 604 to capture the image or may access the image from non-volatile memory 602.

Non-volatile memory 602 may further store a trained machine learning model, comprising parameter values that were adjusted to reduce an error or loss during training. The image represents multiple objects in the image with respective positional information. Processor 601 calculates an embedding of the image data. The embedding comprises an embedding vector for each object, and encodes object information and the positional information. Processor 601 also evaluates a trained machine learning model, stored on non-volatile memory 602 on the calculated embedding to calculate connection probabilities of pair-wise connections between each of the objects in the image. The connection probabilities represent relationships between the objects in the image.

Processor 601 may store the scene graph, comprising the connection probabilities, or confirmed connections with labels on non-volatile memory 602. Processor 601 may also generate an output on a user interface to indicate to the user the scene graph or generate a textual output that represents the scene graph. The scene graph may also be an input to another method, such as an autonomous driving method, or a decision model to determine decisions of a vehicle or other system.

It is noted that the method 200 may equally be performed by multiple processors that are configured to perform the steps of the method. As such, there may be a cloud computing environment with dynamically instantiated resources that perform steps of the method.

### Experiments

In this section, we demonstrate the effectiveness of our method on scene graph generation (SGG) and panoptic scene graph generation (PSG) tasks.

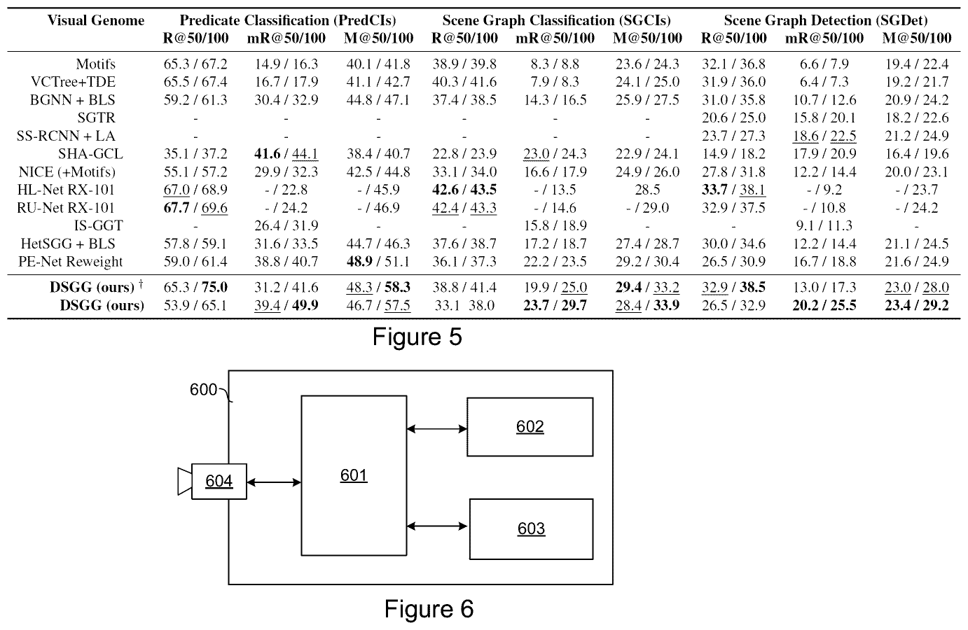

FIG. 5 shows a table of Evaluation on the Visual Genome dataset. The best and second best methods under each setting are marked according to formats. † shows DSGG results without logit adjustment. Comparisons to additional methods are included in the supplementary material.

### Datasets

To evaluate the effectiveness of our approach, we conduct experiments on challenging datasets, namely Visual Genome and PSG dataset. Both these scene graph datasets contain a list of <subject, predicate, object> triplets that are often noisy and duplicated. Additionally, there are several concurrent relationships for objects, or sets of objects, pointing to a relational semantic overlap problem. The following are each dataset's statistics.

Visual Genome (VG) dataset has 108,077 images and their associated scene graph annotations featuring 50 predicate relationships and 150 object categories.

Panoptic Scene Graph (PSG) dataset has 48,749 images, 80 thing classes,

53 stuff categories and 56 predicate relationships. The dataset contains 2,177 test images, with 28 rare predicates and 28 non-rare relation categories. There are multiple relationships among the same objects in 927 images in the test split.

### Evaluation Metrics

We report recall (R), mean recall (mR) and overall mean M@K accuracy (%) on the test set of Visual Genome and Panoptic scene graph generation datasets. We also report predicate classification (PredCIs), scene graph classification (SGCIs), and scene graph detection (SGDet) metrics for the Visual Genome dataset.

### Implementation Details

The DSGG models are trained with 100 graph-aware queries only. Specifically, we use the ResNet-50, Swin-B and Swin-L as the backbone networks. For the SGG task, we trained the DSGG model for 60 epochs only. Note that our models are trained from scratch without a pre-trained object detector on the VG dataset. For the PSG task, in order to provide a fair comparison to the baselines, we only fine-tuned our model initialized with Mask2Former model (pre-trained on the COCO dataset) for 12-epochs. In both settings, we jointly train the shared transformer's encoder and decoder for learning compositional query tokens. These 256-dimensional tokens are then forwarded to class-embedding and box-embedding for learning the labels and bounding boxes for the SGG task. Additionally, we use the segmentation embedding to learn the object's pixel-wise semantic segmentation for the PSG task only. The number of encoder and decoder layers is kept as default and we adopted the same data augmentation settings as in the baselines. The models are trained end-to-end with the sub-graph matching as the default cost function for both SGG and PSG tasks. AdamW is used as an optimizer with a weight decay of 10⁻⁴. We set the initial learning rate of the backbone, transformer, and scene-graph generation to 10⁻⁵, 10⁻⁴, and 10⁻⁴ respectively. Four A100 GPUs are used for both training and evaluating the models; however, for the PSG and SGG tasks, we used batches of 1 and 4 images, respectively.

### Experimental Evaluation

Scene Graph Generation: Table 3 shows scene graph detection results on the test split of the Visual Genome dataset. Our method achieves state-of-the-art recall without the need for any complex post-processing of scene graphs. Note that in this setting, the relation prediction is restricted to unbiased scene graph generation. However, following, we also applied logit adjustment (LA) as a post-processing step to fix the long-tailed issue with relations categories in the dataset. Note that this approach outperforms all the baselines, by a considerable margin in the case of mean recall and the mean@K metric. Specifically, we compare our method with Motifs, Unbiased, BGNN, SGTR, Structured Sparse RCNN, SHA-GCL, NICE, HL-Net, RU-Net, Relationformer, RepSGG, HetSGG, and PE-Net. Note also that our approach with the LA post-processing is competitive in terms of recall.

TABLE 4
Evaluation on the PSG dataset.

| | | Panoptic Scene Graph Detection | | | | | |
|---|---|---|---|---|---|---|---|
| 3-8 Method | Backbone | R@20 | mR@20 | R@50 | mR@50 | R@100 | mR@100 |
| IMP | R50 | 16.5 | 6.5 | 18.2 | 7.1 | 18.6 | 7.2 |
| MOTIF | R50 | 20.0 | 9.1 | 21.7 | 9.6 | 22.0 | 9.7 |
| VCTree | R50 | 20.6 | 9.7 | 22.1 | 10.2 | 22.5 | 10.2 |
| GPSNet | R50 | 17.8 | 7.0 | 19.6 | 7.5 | 20.1 | 7.7 |
| PSGTR | R50 | 28.4 | 16.6 | 34.4 | 20.8 | 36.3 | 22.1 |
| PSGFormer | R50 | 18.0 | 14.8 | 19.6 | 17.0 | 20.1 | 17.6 |
| HiLo † | R50 | 34.1 | 23.7 | 40.7 | 30.3 | 43.0 | 33.1 |
| DSGG (ours) | R50 | 32.7 | 30.8 | 42.8 | 38.8 | 50.0 | 43.4 |
| HiLo † | Swin-B | 38.5 | 28.3 | 46.2 | 35.3 | 49.6 | 39.1 |
| DSGG (ours) | Swin-B | 35.5 | 32.9 | 46.5 | 41.3 | 54.2 | 46.3 |
| HiLo † | Swin-L | 40.6 | 29.7 | 48.7 | 37.6 | 51.4 | 40.9 |
| DSGG (ours) | Swin-L | 36.2 | 34.0 | 47.0 | 41.7 | 54.3 | 47.8 |
| DSGG (ours) † | R50 | 32.2 | 30.9 | 42.5 | 40.1 | 49.7 | 44.1 |
| DSGG (ours) † | Swin-B | 35.8 | 33.9 | 46.3 | 43.2 | 54.5 | 48.7 |
| DSGG (ours) † | Swin-L | 36.0 | 34.1 | 47.0 | 42.1 | 54.7 | 48.0 |

The best and second best methods under each setting are marked according to formats.
† represents the models trained using additional relation labels obtained through a baseline-trained model.

Panoptic Scene Graph Generation: The evaluation of recall and mean recall (%) uses the panoptic segmentation as the default criteria. Table 4 shows performance comparision of DSGG with several baselines. Our method achieves a consistent improvement over all the metrics. An analysis of the top-20 relations\demonstrates slightly improved performance, yet the recall metric is heavily influenced by high-frequency relations. Note that, the other approach yields considerably lower results for the mean-recall metric, which assigns equal weight to all relation classes, and is a better overall metric for scene-graph comparison. The DSGG attains superior results for both metrics across the top 50 and 100 relations on PSG dataset.

### Ablation Studies

In this section, we provide a comprehensive analysis of our model, emphasizing various aspects. Initially, we conducted ablation experiments to evaluate the contributions of individual components in the DSGG model. Furthermore, we perform an ablation study that examines performance using top-scene graph predictions and explores the zero-shot capabilities inherent in our model.

Effectiveness of different components of the model: In this ablation study, we explore how the different components of the model influence the final performance on the VG dataset. In particular, our attention is directed towards understanding the effectiveness of the relation distillation and re-scoring mechanism, and the role of logit adjustment components. Table 5 demonstrates the outcomes for various combinations of these components. Note that our graph-aware queries learn relation triplets more effectively and thus contribute to a significant improvement in the overall performance. The recall is improved by the relation rescoring and distillation modules. However, logit adjustment yields better mean recall and mean performance overall.

TABLE 5
Impact assessment of various components of the model on the
scene graph detection task using the Visual Genome test set.

| | | | Recall | | |
|---|---|---|---|---|---|
| Relation | Relation | Logits | (Main) | Mean Recall | Mean @ K |
| Rescoring | Distillation | Adjustment | R@50/100 | mR@50/100 | M@50/100 |
| | | | 6.9/11.2 | 11.9/15.6 | 9.4/13.4 |
| ✓ | | | 25.9/32.6 | 12.5/15.7 | 19.2/24.2 |
| ✓ | ✓ | | 32.9/38.5 | 13.0/17.3 | 23.0/28.0 |
| ✓ | ✓ | ✓ | 26.5/32.9 | 20.2/25.5 | 23.4/29.2 |

Effectiveness of the model on top predictions: Table 6 shows the influence of the number of graph-aware queries in the transformer on the Visual Genome dataset. During the testing phase, several scene-graph generation approaches struggle with localizing objects and predicates with a smaller number of queries. Note that, our model trained with just 20 queries achieves the best results on both metrics.

Effectiveness of the model on zero-shot learning: We also study the generalization capability of DSGG to unseen relationships. We, therefore, evaluated the zero-shot performance of our method on the Visual Genome test set. Table 6a and 6b show a performance comparison with several baseline approaches. Note that, our model achieves consistently state-of-the-art results on zero-shot recall for all metrics.

TABLE 6a
Evaluation of top-20 relation triplets on the Visual Genome test set.

| Visual Genome | Mean Recall | Recall | Mean @ K |
|---|---|---|---|
| SGDet | mR@20 | R@20 | M@20 |
| Unbiased | 6.9 | 19.0 | 13.0 |
| SS-RCNN | 13.7 | 18.2 | 15.8 |
| SHA-GCL | 14.2 | — | — |
| HL-Net | — | 26.0 | — |
| RU-Net | — | 25.7 | — |
| PE-Net | 9.2 | 23.4 | 16.3 |
| DSGG (ours)† | 8.3 | 23.4 | 15.9 |
| DSGG (ours) | 14.2 | 18.7 | 16.4 |

TABLE 6b
Evaluation of Zero-shot Recall performance
on the Visual Genome test set.

| | |
|---|---|
| Visual Genome | Zero Shot Recall |

| SGDet | zR@50 | zR@100 |
|---|---|---|
| Motifs | 0.1 | 0.1 |
| Motifs + TDE | 2.3 | 2.9 |
| VCTree | 0.3 | 0.7 |
| VCTree + TDE | 2.6 | 3.2 |
| SS-RCNN | 3.1 | 4.5 |
| PE-Net | 2.3 | 3.6 |
| DSGG (ours)† | 2.5 | 3.9 |
| DSGG (ours) | 3.5 | 5.2 |

†shows DSGG results without logit adjustment.

TABLE 7
DSGG and HiLo performance comparison on the PSG dataset's relational semantic
overlap subset. This subset consists of images that show various relationships
between the same objects. Our approach consistently outperforms HiLo.

| | | | Relational Semantic Overlap | | | | |
|---|---|---|---|---|---|---|---|
| 3-8 Method | Backbone | R@20 | mR@20 | R@50 | mR@50 | R@100 | mR@100 |
| HiLo | R50 | 43.6 | 30.8 | 49.7 | 36.2 | 51.1 | 38.8 |
| DSGG (ours) | R50 | 48.6 | 37.6 | 58.2 | 48.6 | 63.6 | 50.2 |
| Δ | | +5.0 | +6.8 | +8.5 | +12.4 | +12.5 | +11.4 |
| HiLo | Swin-B | 51.3 | 36.4 | 57.9 | 42.2 | 59.9 | 45.0 |
| DSGG (ours) | Swin-B | 52.7 | 41.3 | 60.9 | 49.6 | 66.7 | 54.7 |
| Δ | | +1.4 | +4.9 | +3.0 | +7.4 | +6.8 | +9.7 |
| HiLo | Swin-L | 53.1 | 36.3 | 60.7 | 46.7 | 62.6 | 49.0 |
| DSGG (ours) | Swin-L | 53.4 | 42.6 | 62.1 | 50.3 | 68.0 | 55.2 |
| Δ | | +0.3 | +6.3 | +1.4 | +3.6 | +5.4 | +6.2 |

### Analysis

This section outlines the analysis of the proposed DSGG model concerning challenges related to long-tail distribution and relational semantic overlap. All the experiments are carried out on the PSG dataset.

Relational Semantic Overlap: The issue of relational semantic overlap arises when there are several relationships between the same pair of entities. For instance, a typical example is an image where a person is simultaneously holding a horse and looking at it. In this specific section, we focus on assessing the effectiveness of the proposed DSGG method and the baseline approaches when dealing with images that have entities exhibiting relational semantic overlap. The PSG test dataset consists of 927 images that depict multiple relationships between the same entities. Table 7 shows a performance comparison of the proposed DSGG method and the current state-of-the-art HiLo approach, it is evident that the proposed DSGG method excels at effectively addressing the challenge of relational semantic overlap.

Low-frequency Relations: A relation category is deemed rare in the PSG dataset if it encompasses fewer than 500 instances. Table 8 shows a performance comparison of the proposed DSGG method and the HiLo approach. The proposed DSGG method is robust to the rare relation categories and consistently excels at effectively predicting low-frequency relations in the presence of high-frequency predicate categories.

TABLE 8
Performance comparison on the rare relation categories within
the PSG dataset. DSGG consistently outperforms HiLo, demonstrating
superior performance in rare relation categories.

| | | Low-frequency Relations (28) | | |
|---|---|---|---|---|
| 3-5 Method | Backbone | mR@20 | mR@50 | mR@100 |
| HiLo | R50 | 10.4 | 17.0 | 20.3 |
| DSGG (ours) | R50 | 20.9 (+10.5) | 31.0 (+14.0) | 33.7 (+13.4) |
| HiLo | Swin-B | 13.1 | 20.3 | 24.6 |
| DSGG (ours) | Swin-B | 23.0 (+9.9) | 33.9 (+13.6) | 38.1 (+13.5) |
| HiLo | Swin-L | 14.2 | 22.6 | 26.3 |
| DSGG (ours) | Swin-L | 23.6 (+9.4) | 30.1 (+7.5) | 36.0 (+9.7) |

Model Parameters: Another important factor is that our model uses considerably fewer parameters when compared to, which incorporates two decoder streams: High-Low and Low-High. In particular, the DSGG model has a total parameter count of 44.2 M, 107.1 M, and 215.6 M for the resnet-50, swin-b, and swin-1 backbone networks, respectively. In contrast, the model proposed by features 58.8 M, 121.7 M, and 230.3 M parameters for the same backbone networks, respectively. The qualitative comparison of the Visual Genome and the PSG datasets is provided in the supplementary material.

### Conclusion

This disclosure provides a direct graph detection method for scene graph generation that simultaneously predicts objects and their relationships in an end-to-end fashion. The approach employs graph-aware queries learned from dense scene graphs through relaxed sub-graph matching. Compositional tokens are utilized for learning embeddings for class, bounding-box, segmentation, and pairwise relations. Additionally, the method incorporates relation distillation, re-scoring, and post-processing with logit adjustment for a unified end-to-end solution. Extensive experiments on scene graph generation (SGG) and panoptic scene graph generation (PSG) benchmark datasets demonstrate the superior performance of our method, surpassing state-of-the-art results significantly. Ablation studies assess the contribution of each model component, and this disclosure provides an analysis of the model's effectiveness in addressing challenges related to relational semantic overlap and long-tail issues.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

What is claimed:

1. A method for analysing image data representing an image, the image representing multiple objects in the image with respective positional information, the method comprising:
calculating an embedding of the image data, the embedding comprising an embedding vector for each object, and encoding object information and the positional information; and
evaluating a trained machine learning model on the embedding to calculate connection probabilities of pair-wise connections between each of the objects, the connection probabilities representing relationships between the objects in the image.

2. The method of claim 1, wherein evaluating the trained machine learning model comprises calculating connection probabilities for each of multiple possible labels for each of the pair-wise connections.

3. The method of claim 2, wherein the labels comprise predicates or location identifiers or both.

4. The method of claim 1, further comprising:
training a machine learning model on training data to obtain the trained machine learning model, the training data comprising ground truth connection values; and
calculating a correspondence between ground truth pair-wise connection values and pair-wise connection probabilities to calculate a loss value, and adjusting variable values of the machine learning model to reduce the loss value.

5. The method of claim 4, wherein calculating the loss value comprises calculating an entity matching cost and a relationship matching cost.

6. The method of claim 5, wherein calculating the correspondence comprises solving an assignment problem between a ground truth graph representing the training data and a prediction graph generated by the machine learning model.

7. The method of claim 6, wherein the assignment problem is a quadratic assignment problem and the method comprises solving the quadratic assignment problem in a linear form approximating the quadratic assignment problem.

8. The method of claim 1, wherein evaluating the trained machine learning model comprises combining the embedding vector for each of the multiple objects with the embedding vector for other objects.

9. The method of claim 8, wherein combining the embedding vector comprises evaluating a sigmoid activation function to calculate the connection probabilities.

10. The method of claim 1, wherein the connection probabilities comprise, for each pair-wise connection, a probability value for each of multiple predicate labels.

11. The method of claim 1, further comprising selecting a subset of the connection probabilities with the largest value for the connection probabilities.

12. The method of claim 1, wherein the trained machine learning model comprises a multi-layer perceptron to calculate the connection probabilities.

13. The method of claim 1, wherein the trained machine learning model comprises an encoder to calculate the embedding.

14. The method of claim 13, wherein the machine learning model comprises one query for each of the multiple objects to calculate cross-attention values.

15. The method of claim 1, wherein the trained machine learning model further comprises a neural network to detect the objects in the image and to determine the positional information.

16. A computer system comprising:
electronic memory; and
one or more processors that, when executing instructions stored on the electronic memory for analysing image data representing an image, the image representing multiple objects in the image with respective positional information, is configured to:
calculate an embedding of the image data, the embedding comprising an embedding vector for each object, and encoding object information and the positional information; and
evaluate a trained machine learning model on the embedding to calculate connection probabilities of pair-wise connections between each of the objects, the connection probabilities representing relationships between the objects in the image.

17. A non-transitory computer-readable medium with software code stored thereon that, when executed by a computer, causes the computer to analyse image data representing an image, the image representing multiple objects in the image with respective positional information, by
calculating an embedding of the image data, the embedding comprising an embedding vector for each object, and encoding object information and the positional information; and
evaluating a trained machine learning model on the embedding to calculate connection probabilities of pair-wise connections between each of the objects, the connection probabilities representing relationships between the objects in the image.
